(19) United States
(12) Patent Application Publication
(10) Pub. No.: US 2026/0336569 A1
(43) Pub. Date: Oct. 29, 2026

(54) SPRAY NOZZLE OF A SPRAYING DEVICE

(71) Applicant: VALEO SYSTEMES D'ESSUYAGE, La Verriere (FR)

(72) Inventors: Benjamin CHABANNES, La Verriere (FR); Cyrille GIRODOT, La Verriere (FR); Loic ROUSSEL, La Verrière (FR); Philippe PICOT, La Verrière (FR); Sebastien ROLLET, La Verrière (FR); Yoann DOLLE, La Verriere (FR)

(73) Assignee: VALEO SYSTEMES D'ESSUYAGE, La Verriere (FR)

(21) Appl. No.: 19/113,528

(22) PCT Filed: Sep. 18, 2023
(86) PCT No.: PCT/EP2023/075693

§ 371 Date: Mar. 20, 2025

(30) Foreign Application Priority Data
Sep. 21, 2022 (FR) 2209565

(51) Int. Cl. B60S 1/56; B60S 1/52

(52) U.S. Cl. CPC B60S 1/56; B60S 1/52

(57) ABSTRACT

The present invention relates to a spray nozzle of a device for spraying a cleaning fluid. The spray nozzle being intended to be attached to a main body of the spraying device which at least partially defines a duct for conveying the cleaning fluid. The spray nozzle includes at least one channel configured to guide the flow of the cleaning fluid toward a spray outlet for the cleaning fluid. The spray nozzle also includes a wall forming a deflector arranged facing the spray outlet of the channel. The spray nozzle is also formed in a single piece.

### TECHNICAL FIELD

The present invention falls within the field of systems for cleaning detection devices of a vehicle, and relates more particularly to a cleaning device that sprays cleaning liquid onto a detection surface of a detection device.

### BACKGROUND OF THE INVENTION

In recent years, numerous items of equipment have been added to the latest vehicle models. Of these items of equipment, some work through detection devices, such as, for example, autonomous driving systems. The latter comprise a plurality of detection devices such as cameras, radars, LIDARs (light detection and ranging) or else infrared-wave sensors for example. Such detection devices generally comprise a detection surface via which the waves emitted by said detection device are emitted into the external environment surrounding the vehicle on which the autonomous driving system is installed, and through which surface waves returning from the external environment pass. This detection surface is generally optically neutral and must be suitable for not disturbing the signals emitted or received by the detection device.

Systems for cleaning detection devices generally comprise at least one cleaning-the fluid spraying device installed on the detection device and able to spray cleaning fluid against the detection surface of said latter device. Moreover, the cleaning system may comprise, as an alternative or in addition, a circuit able to guide a flow of air toward the detection surface.

The cleaning-fluid spraying device is positioned close to the detection surface of one of the detection devices so as to optimize the cleaning of said detection surface. It is known that such spraying devices comprise at least two elements: a main body and a spray nozzle. The spray nozzle and the main body generally contribute to defining a channel through which the cleaning fluid circulates toward an outlet orifice. The main body additionally comprises a deflector that guides the cleaning fluid against the detection surface. More specifically, the cleaning fluid is sprayed from the outlet orifice of the channel against the deflector so as to generate a flat jet of cleaning fluid aimed toward the detection surface.

It is essential to be able to ensure very accurate positioning of the components relative to one another in order to be certain that the deflector is positioned correctly, both with respect to the channel and with respect to the surface that is to be cleaned. These are the conditions that ensure that the jet impinges on the surface that is to be cleaned with the desired angle of impact and the desired angular spread.

Moreover, the high-pressure spraying of the cleaning fluid against the deflector may cause said deflector to shift with respect to its initial position and cause gapping between the main body and the spray nozzle, such that the cleaning fluid may infiltrate into this gap as the spraying device is progressively used, notably through a capillary action effect. The cleaning fluid that has thus infiltrated may cause damage to the main body and/or to the spray nozzle and, more particularly, damage to the attachment between the main body and the spray nozzle.

The present invention proposes an alternative solution to that which currently exists by proposing a spray nozzle, forming part of a cleaning-fluid spraying device, that allows a jet to be sprayed repeatably and reliably onto the surface that is to be cleaned in a way that conforms to the theoretical calculations while moreover avoiding any infiltration of cleaning fluid at a zone at which the main body and said spray nozzle are welded together.

### SUMMARY OF THE INVENTION

In that context, the main subject of the present invention is a spray nozzle of a device for spraying a cleaning fluid, the spray nozzle being intended to be attached to a main body of the spraying device which at least partially defines a duct for conveying the cleaning fluid, characterized in that the spray nozzle comprises at least one channel configured to guide the flow of the cleaning fluid toward a spray outlet for the cleaning fluid, the spray nozzle further comprising a wall forming a deflector arranged facing the spray outlet of the channel, the spray nozzle being formed in a single piece.

According to the invention, the deflector and the channel are thus part of the one same component: the spray nozzle. More particularly, the spray nozzle is formed as a one-piece element, which is to say that separating one of the constituent elements of the spray nozzle from the other elements would lead to the destruction of one or other of the elements that make up said spray nozzle.

That solves the aforementioned technical problem since incorporating the channel and the deflector into the one same component means that tolerances on the assembly of the spray nozzle with the assembly body do not need to be taken into consideration in order to obtain accurate positioning of the channel and the deflector in relation to one another.

According to one preferred optional feature of the invention, the spray nozzle further comprises an attachment system configured for securing the spray nozzle to the main body of the spray device.

According to one optional feature of the invention, the channel extends along a direction of main extension having an inlet orifice and an outlet orifice, the deflector comprising a wall having a spray face facing the outlet orifice of the channel, the spray face extending mainly in a plane that is secant with the direction of main extension of the channel.

According to another optional feature of the invention, the face via which the channel opens extends in a plane that is secant with the plane containing a face of the deflector onto which face the cleaning fluid is sprayed. This inclination of the face via which the channel opens widens the angular extent of the spray of the cleaning fluid sprayed from the deflector.

According to another optional feature of the invention, the spray nozzle comprises at least a synthetic material, the spray nozzle being produced by injection molding.

Advantageously, the synthetic material is polypropylene, polyurethane, polyamide, polycarbonate, polyoxymethylene, PVC, or ABS.

According to another optional feature of the invention, the spray nozzle comprises a plurality of channels which are arranged next to one another along a direction secant with their direction of main extension, the channels each comprising an outlet orifice, the deflector extending facing each of the outlet orifices of the channels. This then makes it possible to produce a spraying device in the form of a spray boom which is particularly suitable for cleaning a detection device having an extensive detection surface, such as a LIDAR for example.

According to another optional feature of the invention, the deflector comprises a single wall extending facing each of the outlet orifices of the channels.

According to another optional feature of the invention, the deflector comprises a plurality of walls, each of the walls being arranged facing one of the outlet orifices of the channels. This particular configuration makes it possible to generate different spray jets having at least two different spray angles.

According to another optional feature of the invention, the spray nozzle has an internal face configured to face the main body and an opposite external face onto which a spray zone for spraying the cleaning fluid opens, the attachment system being arranged on the internal face.

According to another optional feature of the invention, the spray zone is defined by the deflector and by an inclined plane into which the outlet orifice of the channel facing the deflector opens.

According to another optional feature of the invention, the spray nozzle extends along a direction of main elongation, having a spray end at which at least the deflector and the outlet orifice of the channel are located and an opposite connection end, the spray nozzle comprising a clip-fastening element constituting the attachment system and arranged at the connection end.

Another subject of the present invention is a spraying device of a system for distributing a cleaning fluid, the spraying device comprising a main body contributing to defining a duct for conveying the cleaning fluid, and a spray nozzle characterized in accordance with any one of the foregoing features, the channel communicating fluidically with the conveying duct.

According to another optional feature of the invention, the spraying device comprises a reservoir of the cleaning fluid arranged between the conveying duct and the channel of the spray nozzle, the spray nozzle at least partially contributing to defining the reservoir.

According to another optional feature of the invention, the reservoir is defined both by the main body and by the spray nozzle.

According to another optional feature of the invention, the main body comprises a housing for the spray nozzle, the deflector having an internal surface facing the outlet orifice of the channel and an external surface facing a wall of the main body contributing to defining the housing.

In that context, it is notable that the spraying of the cleaning fluid from the channel against the deflector may cause the deflector to shift from its initial position, but in the form of pushing it toward a wall of the main body that contributes to defining the housing. The spraying of the cleaning fluid therefore has the effect of reducing any gap there might be between the spray nozzle and the main body, and this has the effect of preventing cleaning fluid from infiltrating between the spray nozzle and the main body, avoiding premature damage to these.

According to another optional feature of the invention, the attachment system is a weld connecting the internal face of the spray nozzle and the main body.

According to another optional feature of the invention, the weld is an ultrasound weld.

According to another optional feature of the invention, the weld lies in a single plane.

According to another optional feature of the invention, the weld extends over the periphery of the internal face of the spray nozzle.

According to another optional feature of the invention, the spraying device comprises positioning means for positioning the spray nozzle on the main body, these positioning means comprising at least a rib and a groove collaborating with the rib, the rib and the groove being arranged one of them on the spray nozzle and the other on the main body.

According to another optional feature of the invention, the weld between the spray nozzle and the main body is produced near the positioning means. What is meant by near the positioning means is, for example, that the weld is produced on the same surface as the surface on which the rib is produced or as the surface on which the groove is produced.

A final subject of the present invention is a system for distributing a cleaning fluid, comprising at least a reservoir of cleaning fluid and a spraying device for spraying the cleaning fluid characterized in accordance with any one of the foregoing features, and a conveying duct for conveying the cleaning fluid and fluidically connecting the cleaning-fluid reservoir to the spray nozzle.

### BRIEF DESCRIPTION OF DRAWINGS

Other features, details and advantages of the invention will become more clearly apparent on reading the description below and on studying several exemplary embodiments given by way of non-limiting indication with reference to the appended schematic drawings, in which:

FIG. 1 is a perspective depiction of a spraying device comprising a spray nozzle according to the invention;

FIG. 2 is a view in longitudinal section of a spray nozzle according to a first embodiment of the invention; and

FIG. 3 is a view in longitudinal section of a spray nozzle according to a second embodiment of the invention.

### DETAILED DESCRIPTION OF THE INVENTION

The features, variants and the various embodiments of the invention may be combined with one another, in various combinations, as long as they are not mutually incompatible or mutually exclusive. In particular, variants of the invention can be imagined comprising only a selection of features described hereinafter in isolation from the other features described, if this selection of features is sufficient to confer a technical advantage and/or to differentiate the invention from the prior art.

In the figures, elements common to several figures have the same reference sign.

In addition, the terms “upstream” and “downstream” used hereinafter in the description refer to the direction of circulation of a cleaning fluid through the spraying device.

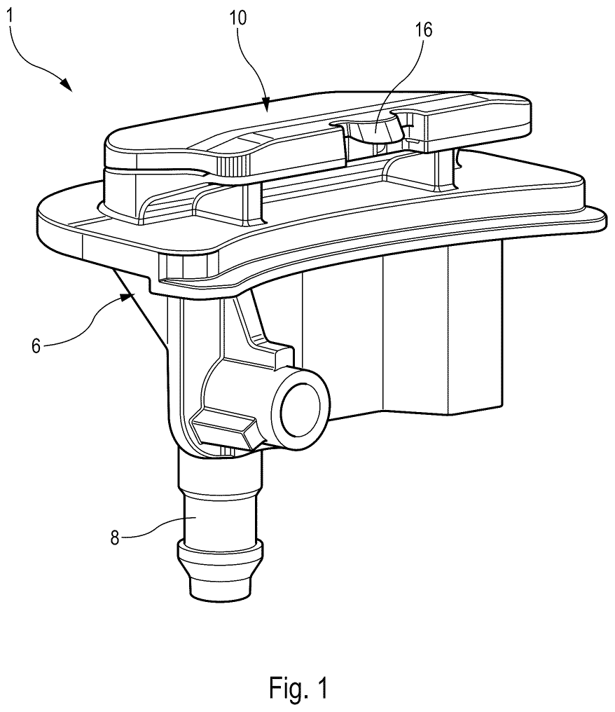

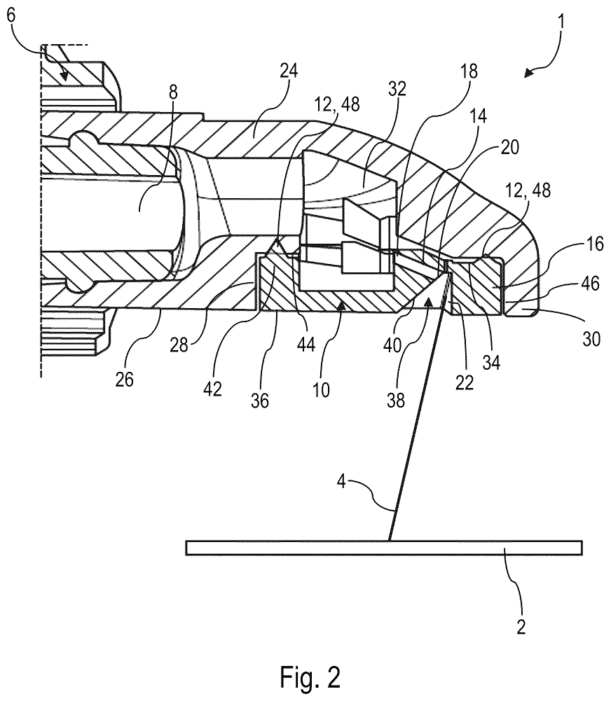

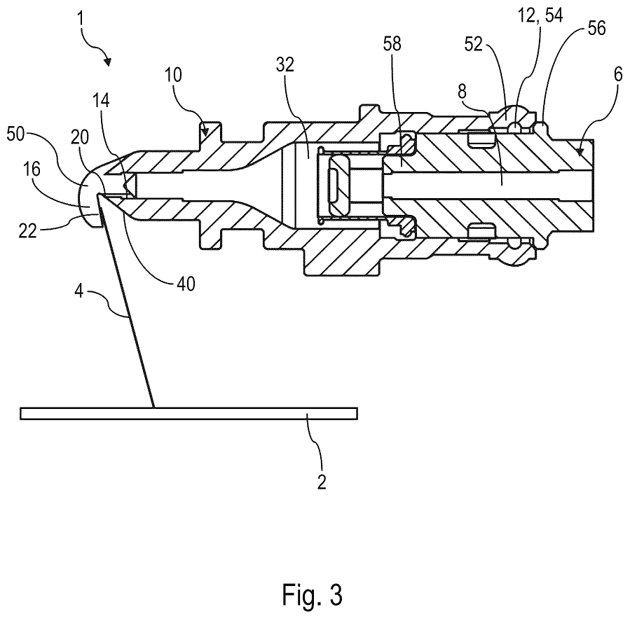

FIG. 1 illustrates a spraying device 1 of a cleaning-fluid distribution system, the spraying device 1 being configured to spray a jet 4 of cleaning fluid against a detection surface 2 of a detection device, as visible in FIG. 2 or FIG. 3.

More particularly, the detection device comprises, on the one hand, a main component part comprising for example a sensor, and, on the other hand, the detection surface 2 positioned between the sensor housed in the main component part and the external environment surrounding the detection device. The sensor of the detection device may for example be a camera, a radar or even a LIDAR, this list not being exhaustive. This type of detection device emits and/or receives electromagnetic waves to and/or from the external environment surrounding the detection device in order to detect one or more objects present in this environment. The detection surface 2 is designed so that the electromagnetic waves emitted and/or received by the sensor can pass through said detection surface 2 without being deflected or modified.

The spraying device 1 intended to be connected to a cleaning-fluid distribution network not depicted here is configured to spray the cleaning fluid in the form of a jet 4 against the detection surface 2 of the detection device at a determined angle of impingement on the detection surface, it being possible as applicable for the jet to be a flat jet extending mainly in one plane. The spraying of the cleaning fluid by the spraying device 1 thus allows the detection surface 2 to be cleaned of everything, whether this be dirt or droplets, deposited thereon and liable to hamper image acquisition.

To do that, and as visible in FIGS. 2 and 3, the spraying device 1 more particularly comprises a main body 6 contributing to defining a conveying duct 8 for conveying the cleaning fluid, and a spray nozzle 10 according to the invention. The main body 6 is configured to guide the cleaning fluid from the cleaning-fluid distribution network as far as the spray nozzle 10, the latter being configured to spray the cleaning fluid toward the detection surface 2 of the detection device. The spray nozzle 10 comprises an attachment system 12 for attachment to the main body 6 so as to secure the spray nozzle 10 to the main body 6.

According to the invention, the spray nozzle 10 comprises at least one channel 14 configured to guide the flow of the cleaning fluid toward an outlet orifice 20 for the cleaning fluid, the spray nozzle 10 further comprising a wall forming a deflector 16 arranged facing the spray outlet of the channel 14, the spray nozzle 10 being formed in a single piece. In other words, the deflector 16 and the channel 14 form part of the spray nozzle 10. More particularly, the spray nozzle 10 is formed as a one-piece element, which is to say that separating one of the constituent elements of the spray nozzle 10 from the other elements would lead to the destruction of one or other of the elements that make up said spray nozzle 10, and this one-piece element is produced in such a way as to house within it a deflector and a channel with an outlet orifice arranged facing the deflector.

As visible in the illustrated example, the channel 14 extends along a direction of main extension having an inlet orifice 18 and the outlet orifice 20, the deflector 16 comprising a wall having a spray face 22 facing the outlet orifice 20 of the channel 14, the spray face 22 extending mainly in a plane that is secant with the direction of main extension of the channel 14. It is notably the control over the magnitude of the angle between the spray face and the direction of main extension of the channel 14, combined with the control over the distance between the spray face 22 and the outlet orifice 20, that makes it possible to ensure that the jet 4 conforms to the desired jet for cleaning the detection surface 2 of the detection device. The fact that, as previously mentioned, the channel 14 and the deflector 16 are produced in the same one-piece component makes it possible to limit the impact of the manufacturing tolerances and not to need to take assembly tolerances into consideration in order to ensure that the deflector 16 is correctly positioned relative to the channel and the outlet orifice 20 thereof.

The channel 14 communicates fluidically with the conveying duct 8, which means that the cleaning fluid circulating in the conveying duct 8 also circulates through the channel 14 to be sprayed toward the deflector 16.

Moreover, as a preference, the spray nozzle 10 comprises at least a synthetic material, the spray nozzle 10 being produced by injection molding. However, a spray nozzle 10 produced using additive manufacturing would be conceivable and would not constitute a departure from the scope of the invention.

Advantageously, the synthetic material is polypropylene, polyurethane, polyamide, polycarbonate, polyoxymethylene, PVC, or ABS.

A first embodiment of the spraying device 1 will now be described with reference to FIG. 2 before describing a second embodiment of the spraying device 1.

As illustrated in FIG. 2, the main body 6 has an upper edge 24 and an opposite lower edge 26, the spray nozzle 10 being arranged on the lower edge 26 of said main body 6. The terms “upper” and “lower” are assigned here arbitrarily, and are not intended to indicate any spatial positioning of the spraying device 1.

Advantageously, the main body 6 comprises a housing 28 for the spray nozzle 10 so that the spray nozzle 10 can be inset and so that it does not project from the lower edge 26. In a cross section through the spraying device 1 viewed in a plane parallel to a direction of main elongation of the conveying duct 8 and substantially perpendicular to the upper edge 24 and lower edge 26, the housing 28 adopts a rectangular overall shape defined by three walls of the lower edge 26 and open on the opposite side from the upper edge. As illustrated, the spray nozzle 10 has a shape that complements that of the housing 28: a cross section through the spray nozzle 10 viewed in a plane parallel to that mentioned hereinabove in that case has a rectangular shape intended to collaborate with the housing 28 in the shape of a rectangle open on the opposite side from the upper edge 24.

Among the walls that define the housing 28 there may notably be discerned an end wall 30 which extends at one of the longitudinal ends of the main body 6. The end wall 30 thus forms a wall acting as an end-stop for the longitudinal shifting of the spray nozzle 10 when the latter is placed in the housing as illustrated in FIG. 2. More particularly, that wall of the spray nozzle that forms the deflector 16 has an external face 46 facing this end wall 30, the external face 46 being the opposite face from the spray face 22 mentioned earlier. It will be appreciated that the external face 46 of the deflector 16, when the deflector 16 is shifted under the force exerted by the spraying of the cleaning fluid, comes to bear against the end wall 30. This has the effect of limiting the deformation of said deflector 16 but also of ensuring that the deflector is pressed firmly against the end wall when the fluid is sprayed, thus avoiding any risk of fluid droplets infiltrating through capillary action between the spray nozzle 10 and the main body 6.

The spraying device 1 comprises a reservoir 32 of the cleaning fluid arranged between the conveying duct 8 and the channel 14 of the spray nozzle 10 such that the reservoir forms a buffer zone between the conveying duct of the main body and the channel of the spray nozzle. The purpose of the reservoir 32 is therefore to at least partially store some of the cleaning fluid arriving from the conveying duct 8 before said cleaning fluid circulates through the channel 14.

The reservoir 32 is defined both by the main body 6 and by the spray nozzle 10. The reservoir 32 is more particularly formed by a cavity formed in the lower edge 26 of the main body, in the region of the housing, and by a bowl formed in the spray nozzle, arranged in the continuation of the cavity when the spray nozzle 10 is fixed on the main body, as illustrated in FIG. 2.

The spray nozzle 10 has an internal face 34 intended to face the main body 6 and in which the bowl that contributes to forming the reservoir is hollowed, and an opposite external face 36 intended to face toward the surface that is to be cleaned and in which a cleaning-fluid spray zone 38 is hollowed. The spray zone 38 consists in a recess in the spray nozzle in which the cleaning fluid circulates from the outlet orifice 20 of the channel 14 toward the spray face 22 of the deflector and then from the spray face toward the outside of the spray nozzle at the appropriate angle for being directed, in the form of a flat jet 4 where applicable, toward the surface that is to be cleaned. It will be appreciated that the fluid emerges from the spray nozzle 10 via the spray zone 38.

In this context, it is notable that the channel 14 of the spray nozzle 10 which, according to the invention, is wholly defined within the spray nozzle 10, is arranged in the thickness of a wall of the spray nozzle and, on the side having its inlet orifice 18 opens into the bowl that contributes to forming the reservoir 32 and, on the side having its outlet orifice 20, opens into the spray zone 38.

The spray zone 38 is defined, on the one hand by the deflector 16 and the spray face 22 thereof and, on the other hand, by an inclined plane 40 into which the outlet orifice 20 of the channel 14 opens.

The inclined plane 40 extends in a plane secant with the plane containing the spray face 22 of the deflector 16. This inclination of the face 40 via which the channel 14 opens widens the angular extent of the spray of cleaning fluid sprayed from the deflector 16. The inclined plane 40 is oriented in such a way that the longitudinal dimension of the spray zone increases with increasing proximity to the external face 36 of the spray nozzle. An angle is formed between the plane containing the inclined plane 40 and the plane containing the spray face 22 of the deflector 16, as illustrated in FIG. 2 and FIG. 3. This angle is needed so that the flat jet 4 of cleaning fluid can be directed against the detection surface 2 of the detection device without the flat jet being disturbed by the inclined plane 40.

The spray nozzle comprises on its internal face 34 a peripheral flank 42 surrounding the cavity that forms part of the reservoir, this peripheral flank 42 being in contact with the main body 6 and notably with a back wall 44 of the housing formed in the main body.

The wall forming the deflector 16 extends plumb with the peripheral flank, at that longitudinal end of the spray nozzle that is intended to face the end wall 30 of the main body, as previously mentioned.

The peripheral flank 42 notably enables implementation of the attachment system 12 and of the positioning means 48 for attaching/positioning the spray nozzle 10 to/on the main body 6.

The positioning means 48 comprise a male member/female member assembly and, by way of example, a pair made up of a rib and a groove collaborating with the rib, the male member and the female member being arranged one of them on the spray nozzle 10 and the other on the main body 6. It will be appreciated that the positioning means 48 allow for adjustment of the position of the spray nozzle 10 in relation to the main body 6 during the mounting of the spray nozzle 10 on the main body 6. In the example illustrated here, the spray nozzle 10 bears a rib forming a male member able to collaborate with a groove forming a female member borne by the main body 6.

The positioning means 48 may, as illustrated, be arranged on the peripheral flank 42, longitudinally one on each side of the cavity that contributes to forming the reservoir 32.

More particularly, the positioning means 48 are at least partially arranged on the spray nozzle 10 on the peripheral flank 42 plumb with the deflector 16 so as best to maintain the position of the deflector with respect to the end wall 30 of the main body 6.

According to the invention, the attachment system 12 is a weld connecting the spray nozzle 10 and the main body 6, more particularly connecting the internal face 34 of the spray nozzle and the back wall 44 of the receiving housing formed in the main body 6. The weld is notably produced on the peripheral flank 42, around the entire periphery thereof, so that the weld is produced all around the reservoir 32. As a preference, the weld is an ultrasound weld. This weld here enables the spray nozzle 10 to be attached to the main body 6 by a melding of materials, therefore preventing the spray nozzle 10 from being able to be detached from the main body 6.

In addition, a weld between the spray nozzle 10 and the main body 6 tends to seal the conveying duct 8 and/or the reservoir 32 against the external surroundings, preventing any leaks of cleaning fluid at the region of connection between the spray nozzle 10 and the main body 6.

As illustrated in FIG. 2, the weld lies in a single plane. It will be appreciated that the internal face 34, and notably the peripheral flank 42, on which the weld of the attachment system 12 is formed, lies in a plane that is parallel to the plane of that face of the main body 6 to which said internal face 34 of the spray nozzle 10 is welded, namely in this instance the back wall 44 of the housing 28.

In the example illustrated, the weld between the spray nozzle 10 and the main body 6 is produced in the region of the positioning means 48. It will be appreciated here that once the spray nozzle 10 has been mounted against the main body 6, and the rib of the positioning means 48 has been arranged in the groove of the positioning means 48, the weld is produced at these positioning means 48. Creating the weld between the spray nozzle 10 and the main body 6 at the positioning means 48 formed by interacting male and female members encourages the melding of the materials of the spray nozzle 10 and of the main body 6 and optimizes the resultant weld.

According to one particular exemplary embodiment that has not been depicted in the figures, the spray nozzle 10 comprises a plurality of channels 14 which are arranged next to one another along a direction secant with their direction of main extension, the channels 14 each comprising an outlet orifice 20 opening via an inclined plane facing the deflector 16. It will be appreciated here that the channels 14 form a spray boom, producing a plurality of either temporally-staggered or simultaneous sprays of cleaning fluid against the deflector 16, these temporally-staggered or simultaneous sprays of cleaning fluid then going on to form different flat jets 4 of spray.

This deflector 16 may just as well be formed by a single wall extending facing each of the outlet orifices 20 of the channels 14, or else by a plurality of walls, each of the walls being arranged facing one of the outlet orifices 20 of the channels 14. The latter configuration provides an easy way of generating different spray angles for one or more of the jets of spray produced by the spray boom.

A second embodiment of the invention will now be described with reference to FIG. 3. Elements that are common to the two embodiments will retain the same references throughout the description of this second embodiment of the invention.

As illustrated in FIG. 3, the spray nozzle 10 takes the form of an endpiece arranged at one end of the main body 6.

More particularly, the spray nozzle 10 extends along a direction of main elongation, having a spray end 50 at which at least the deflector 16 and the outlet orifice 20 of the channel 14 are located and an opposite connection end 52 configured to be connected to the main body.

The spray nozzle 10 comprises a clip-fastening element 54 constituting the attachment system 12 and arranged at the connection end 52.

The spray nozzle 10 here comprises an annular wall at least partially defining the reservoir 32 and a housing of the main body 6. This annular wall is open at the connection end 52 so as to receive the main body 6 and, more particularly, a coupling end 58 into which the conveying duct 8 conveying the cleaning fluid opens.

The clip-fastening element 54 comprises for example an elastically deformable member installed at the connection end 52 of the spray nozzle 10, the elastically deformable member being intended to collaborate with a rigid member 56 belonging to the main body 6. FIG. 3 illustrates a step of mounting the spray nozzle 10 on the main body, just before the clip-fastening element 54 engages on the rigid member 56, through a translational movement along its direction of main elongation.

It will be appreciated here that the spray nozzle 10 has, successively, along the direction of main elongation, a connection portion contributing to defining the reservoir 32 and the housing in the main body 6, and a spray portion comprising the deflector 16 and the channel 14. As a result, the spraying device according to the invention differs from that which may have been described previously in that the deflector 16 does not rest against a wall of the main body 6. However, according to the invention, the spray nozzle forms a one-piece assembly comprising a spray zone 38, a channel 14 supplying cleaning fluid to this spray zone, and a deflector defining the spray zone and against which the cleaning fluid is sprayed as it leaves the channel 14. Here again, combining all of these elements into a single one-piece component that is also attached to the main body makes it possible to control the arrangement of the channel 14 with respect to the deflector thus ensuring that the outlet orifice 20 and the inclined plane 40 in which the outlet orifice is contained are correctly positioned with respect to the deflector 16.

The invention thus achieves its set goal regardless of the embodiment described by proposing a spray nozzle 10 comprising both a channel 14 able to spray a cleaning fluid and a deflector 16 against which the cleaning fluid is sprayed, with the spray nozzle 10 being formed as a single piece. This design makes it possible to ensure that the elements involved in orienting the jet of fluid that is to be directed onto the surface that is to be cleaned are positioned correctly with respect to one another and promotes the fluid tightness of a spraying device on which the spray nozzle is installed, preventing cleaning-fluid spray from being able to infiltrate between elements that make up the spraying device.

The present invention is not however limited to the means and configurations described and illustrated herein and it also extends to any equivalent means and configuration and to any technically feasible combination of such means

1. A spray nozzle of a device for spraying a cleaning fluid, the spray nozzle intended to be attached to a main body of the spraying device at least partially defining a duct for conveying the cleaning fluid, the spray nozzle comprises at least one channel configured to guide the flow of the cleaning fluid toward a spray outlet for the cleaning fluid, and a wall forming a deflector arranged facing the spray outlet of the channel, with the spray nozzle being formed in a single piece.

2. The spray nozzle as claimed in claim 1, further comprising an attachment system configured for securing the spray nozzle to the main body of the spray device.

3. The spray nozzle as claimed in claim 1, wherein the spray nozzle is produced by injection molding.

4. The spray nozzle as claimed in claim 1, further comprising a plurality of channels which are arranged next to one another along a direction secant with a direction of main extension, the channels each including an outlet orifice, the deflector extending facing each of the outlet orifices of the channels.

5. The spray nozzle as claimed in claim 2, having an internal face configured to face the main body and an opposite external face onto which a spray zone for spraying the cleaning fluid opens, the attachment system being arranged on the internal face.

6. The spray nozzle as claimed in claim 2, extending along a direction of main elongation, having a spray end at which at least the deflector and an outlet orifice of a channel are located and an opposite connection end, the spray nozzle including a clip-fastening element constituting the attachment system and arranged at the connection end.

7. A spraying device of a system for distributing a cleaning fluid, the spraying device comprising a main body contributing to defining a duct for conveying the cleaning fluid, and a spray nozzle, with the spray nozzle including at least one channel configured to guide the flow of the cleaning fluid toward a spray outlet for the cleaning fluid, and a wall forming a deflector arranged facing the spray outlet of the channel, with the spray nozzle being formed in a single piece, the channel communicating fluidically with the conveying duct.

8. The spraying device as claimed in claim 7, further comprising reservoir of the cleaning fluid arranged between the conveying duct and the channel of the spray nozzle, the spray nozzle at least partially contributing to defining the reservoir.

9. The spraying device as claimed in claim 7, wherein the main body includes a housing for the spray nozzle, the deflector having an internal surface facing an outlet orifice of the channel and an external surface facing a wall of the main body contributing to defining the housing.

10. The spraying device as claimed in claim 9, wherein the an attachment system is a weld connecting the internal face of the spray nozzle and the main body.

11. The spraying device as claimed in claim 10, wherein the weld extends around a periphery of the internal face of the spray nozzle.

12. The spraying device as claimed in claim 7, further comprising positioning means for positioning the spray nozzle on the main body, the positioning means including at least a rib and a groove collaborating with the rib, the rib and the groove being arranged with one of them on the spray nozzle and the other on the main body.

13. A system for distributing a cleaning fluid, comprising at least a reservoir of cleaning fluid and a spraying device for spraying the cleaning fluid, with the spraying device including a main body contributing to defining a duct for conveying the cleaning fluid, and a spray nozzle, with the spray nozzle including at least one channel configured to guide the flow of the cleaning fluid toward a spray outlet for the cleaning fluid, and a wall forming a deflector arranged facing the spray outlet of the channel, with the spray nozzle being formed in a single piece, and a conveying duct for conveying the cleaning fluid and fluidically connecting the cleaning-fluid reservoir to the spray nozzle.
